(19) United States
(12) Patent Application Publication
(10) Pub. No.: US 2006/0262566 A1
(43) Pub. Date: Nov. 23, 2006

(54) Light guide plate and backlight module

(75) Inventor: Wen-Hui Yao, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/438,832

(22) Filed: May 23, 2006

(30) Foreign Application Priority Data
May 23, 2005 (TW) 94208349

(51) Int. Cl. F21V 7/04

(52) U.S. Cl. 362/616

(57) ABSTRACT

A backlight module (30) has a light guide plate (300) and a light source (320) opposite to the light guide plate. The light guide plate has a first light incident surface (306), a second light incident surface (308) adjacent the first light incident surface, and a groove (303) drilling through the first and second light incident surfaces at an intersection of the first and second light incident surfaces. A bent region of the light source is accommodated in the groove.

### FIELD OF THE INVENTION

The present invention relates to light guide plates and backlight modules, and especially to light guide plates and backlight modules typically used for a liquid crystal display (LCD).

### BACKGROUND

Liquid crystal displays are commonly used as display devices for compact electronic apparatuses, because they not only provide good quality images with little power but also are very thin. The liquid crystals in a liquid crystal display do not emit any light themselves. The liquid crystals have to be lit by a light source so as to clearly and sharply display text and images. Thus, a backlight module for an LCD is generally needed.

Referring to FIG. 11, a related backlight module 10 includes a light guide plate (LGP) 100 and a light source 120. The light source 120 is a linear light source, which is disposed adjacent to an incident surface 102 of the LGP 100. Light beams from the light source 120 are directed into the LGP 100 through the incident surface 102. In assembly, the linear light source 120 has a shorter length, therefore, the illumination of the backlight module 10 is lower and the backlight module 10 can't provide a higher brightness to a liquid crystal panel.

Referring to FIG. 12, another related backlight module 20 includes a light guide plate (LGP) 200 and a light source 220. The light source 220 is an L-shaped light source, which has a bent region 222 connecting two linear regions (not labeled). The LGP 200 is in a shape of rectangle, which has two light incident surfaces 202, 204, and a corner at the intersection of the two light incident surfaces 202, 204. The light source 220 is disposed adjacent to the two adjacent incident surfaces 202, 204, and the bent region 222 is opposite the corner 205 of the LGP 200. Light beams from the light source 220 are directed into the LGP 200 through the two incident surfaces 202, 204. In assembly, the bent region 222 faces the corner 205. Because the corner 205 has a point, the operator needs special carefulness in the process of assembling the light source 220 to the LGP 200 for preventing the point of the corner 205 from destroying the bent region 222 of the light source 220. In addition, a gap between the light source 220 and the two incident surfaces 202, 204 is larger because the corner 205. Thus, the backlight module has a larger size.

What is needed, therefore, is a compact backlight module.

### SUMMARY

In an experiment example, a backlight module is provided. The backlight module has a light guide plate and a light source opposite to the light guide plate. The light guide plate has a first light incident surface, a second light incident surface adjacent the first light incident surface, and a groove through the first and second light incident surfaces. A bent region of the light source is accommodated in the groove.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic, isometric view of a light guide plate according to a first embodiment of the present invention, which has a bottom surface, an incident surface, orthogonal connecting with the bottom surface, and a groove at a corner of the light guide plate;

FIG. 2 is an enlarged view showing an edge formation of the groove, projected at the bottom surface of the light guide plate shown in FIG. 1;

FIG. 3 is an enlarged view showing an edge formation of the groove, projected at the incident surface of the light guide plate shown in FIG. 1;

FIG. 4 is an enlarged view showing an edge formation of a groove of a light guide plate according to a second embodiment of the present invention, projected at a bottom surface of the light guide plate;

FIG. 5 is an enlarged view showing an edge formation of the groove shown in FIG. 4, projected at an incident surface of the light guide plate;

FIG. 6 is an enlarged view showing an edge formation of a groove of a light guide plate according to a third embodiment of the present invention, projected at a bottom surface of the light guide plate;

FIG. 7 is an enlarged view showing an edge formation of the groove, shown in FIG. 6, projected at an incident surface of the light guide plate,

FIG. 8 is an enlarged view showing an edge formation of a groove of a light guide plate according to a fourth embodiment of the present invention, projected at a bottom surface of the light guide plate;

FIG. 9 is an enlarged view showing an edge formation of a groove of a light guide plate according to a fifth embodiment of the present invention, projected at a bottom surface of the light guide plate;

FIG. 10 is an schematic, isometric view of a backlight module according to a sixth embodiment of the present invention;

FIG. 11 is a schematic, isometric view of a related backlight module; and

FIG. 12 is a schematic, isometric view of another related backlight module.

### DETAILED DESCRIPTION OF PREFERRED EMBODIMENTS

Reference will now be made to the drawings to describe the preferred embodiments in detail.

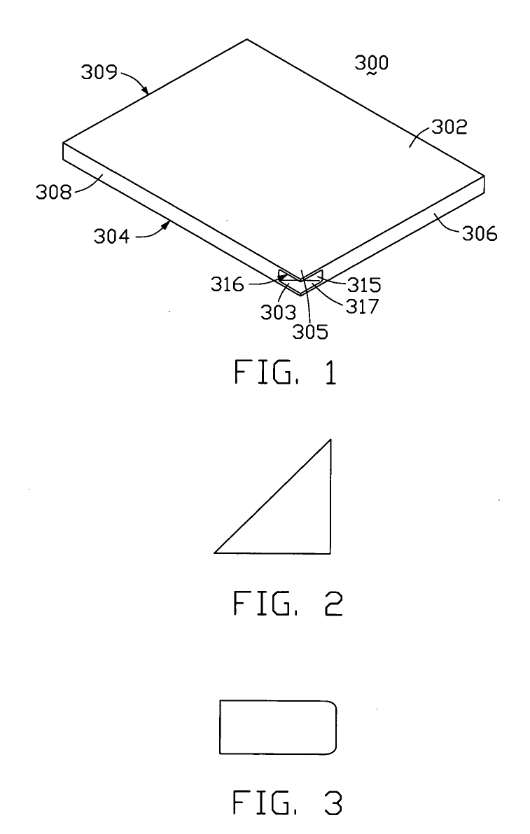

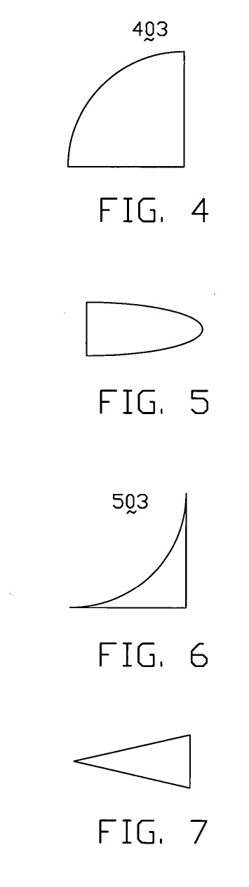

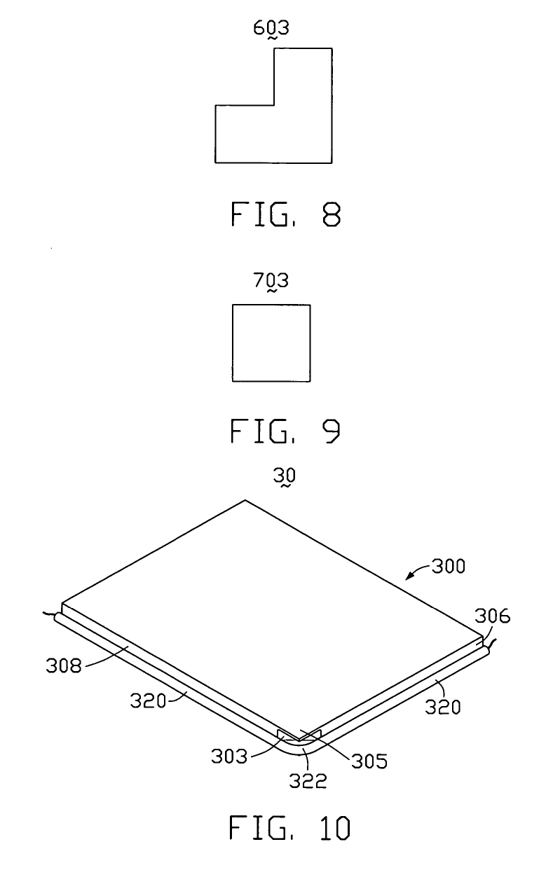

Referring to FIG. 1, FIG. 2 and FIG. 3, an LGP 300 according to a first embodiment of the present invention includes a bottom surface 304, a light emitting surface 302 opposite to the bottom surface 304, a first light incident surface 306 orthogonal connecting with the bottom surface 304 and the light emitting surface 302, a second light incident surface 308 adjacent to the first light incident surface 306, a corner 305 at an intersection of the first and second light incident surfaces 306, 308. The LGP 300 is in a shape of rectangular.

The corner 305 defines a chamfered groove 303 in a center region, drilling through the first and second light incident surfaces 306, 308. The chamfered groove 303 has a first side surface 316, a third side surface 317 opposite to the first side surface 316, and a second side surface 315 orthogonal connecting the first and third side surfaces 315, 317. The chamfered groove 303 has a right triangle projection projected on the bottom surface 304, and has a similar rectangle projection vertically projected on either one of the first and second light incident surfaces 306, 308.

A light guide plate according to a second embodiment of the present invention has a similar structure of that of the light guide plate 300, except a groove 403. The groove 403 has a fan-shaped projection projected at a bottom surface (not shown) of the light guide plate, and a half-ellipse projection projected at an incident surface (not shown) of the light guide plate.

A light guide plate according to a third embodiment of the present invention has a similar structure of the light guide plate 300, except a groove 503. The groove 503 has an irregular projection projected at a bottom surface (not shown) of the light guide plate. The irregular projection has two orthogonal intersection sides and a tangent curve of the two orthogonal intersection sides. The groove 503 further has a triangle projection projected at an incident surface (not shown) of the light guide plate.

A light guide plate according to a fourth embodiment of the present invention has a similar structure of the light guide plate 300, except a groove 603. The groove 603 has an L-shaped projection projected at a bottom surface (not shown) of the light guide plate.

A light guide plate according to a fifth embodiment of the present invention has a similar structure of the light guide plate 300, except a groove 703. The groove 703 has an square projection projected at a bottom surface (not shown) of the light guide plate.

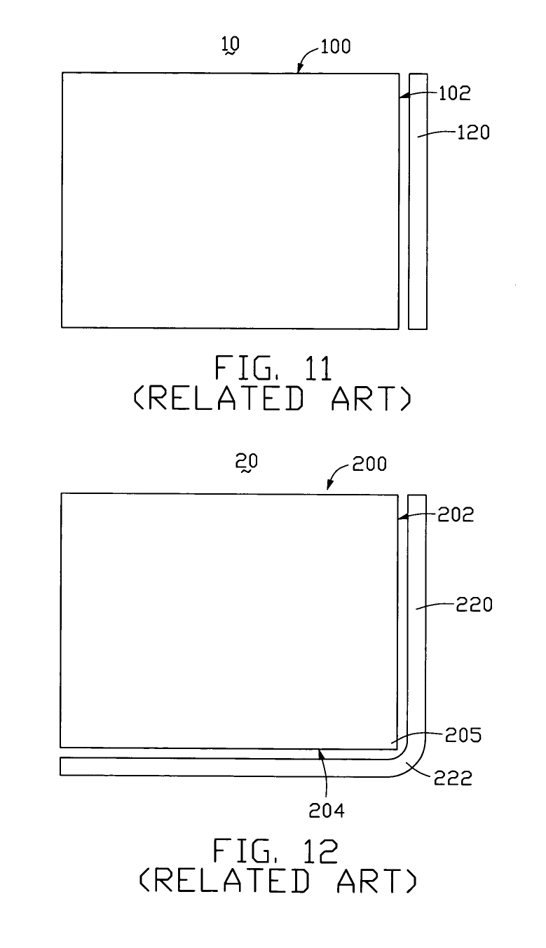

Referring to FIG. 10, a backlight module 30 according to a fifth embodiment of the present invention is shown. The backlight module 30 includes the LGP 300 and an L-shaped light source 320, in general, a cold cathode fluorescent lamp (CCFL). The light source 320 has two linear regions (not labeled) and a bent region 322 between the two linear regions. The light source 320 is disposed adjacent to the LGP 300, the two linear regions being opposite to the first and second light incident surfaces 306, 308, and the bent region 322 of the LGP 300 being opposite to and accommodated in the chamfered groove 303 through the first and second light incident surfaces 306, 308 of the LGP 300.

In operation, a portion of light beams emitted by the light source 32 enters the LGP 31 through the first light incident surface 306 and the second light incident surface 308. Another portion of the light beams travels to a reflector (not shown), and is reflected by the reflector to the first light incident surface 306 and the second light incident surface 308.

Because the bent region 322 of the L-shaped light source 320 is disposed in the chamfered groove 303, the chamfered groove 303 can prevent the light source 320 from destroying by the point part of the corner 305 of the light guide plate. In addition, the backlight module 30 can effectively locate the light source 320 and reduce the gap between the light source 320 and the incident surfaces 306, 308 for improving the utilization of the light beams and providing has a smaller size. Moreover, the backlight module 30 can provide a higher brightness to a liquid crystal display.

In alternative changes, the L-shaped light source 320 can be a U-shaped light source and the chamfered groove 303 can be two for accommodating the two bent regions of the U-shaped light source.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate, comprising:
a first light incident surface;
a second light incident surface adjacent to the first light incident surface;
a groove drilling through the first and second light incident surfaces at an intersection of the first and second light incident surfaces, and
a light source having a bent region in the groove.

2. The backlight module as claimed in claim 1, wherein the light guide plate further comprises a bottom surface adjacent to the first light incident surface, and a light emitting surface opposite to the bottom surface.

3. The backlight module as claimed in claim 1, wherein the groove has a right triangle projection projected on the bottom surface.

4. The backlight module as claimed in claim 3, wherein the groove further has a similar rectangle projection projected on either one of the first and second light incident surfaces.

5. The backlight module as claimed in claim 1, wherein the groove has a fan-shaped projection projected on the bottom surface.

6. The backlight module as claimed in claim 5, wherein the groove further has a half-ellipse projection projected on either one of the first and second light incident surfaces.

7. The backlight module as claimed in claim 1, wherein the groove has an irregular projection projected on the bottom surface.

8. The backlight module as claimed in claim 7, wherein the irregular projection has two orthogonal intersection sides and a tangent curve of the two orthogonal intersection sides.

9. The backlight module as claimed in claim 8, wherein the irregular projection further has a triangle projection at an incident surface of the light guide plate.

10. The backlight module as claimed in claim 1, wherein the light source is L-shaped or U-shaped.

11. A light guide plate, comprising:
at least two adjacent incident surfaces;
at least one groove drilling through the at least two adjacent light incident surfaces.

12. The light guide plate as claimed in claim 11, further comprising a bottom surface adjacent the first light incident surface, and a light emitting surface opposite to the bottom surface.

13. The light guide plate as claimed in claim 11, wherein the groove has a right triangle projection vertically projected on the bottom surface.

14. The light guide plate as claimed in claim 13, wherein the groove further has a similar rectangle projection vertically projected on either one of the first and second light incident surfaces.

15. The light guide plate as claimed in claim 11, wherein the groove has a fan-shaped projection vertically projected on the bottom surface.

16. The light guide plate as claimed in claim 15, wherein the groove further has a half-ellipse projection vertically projected on either one of the first and second light incident surfaces.

17. The light guide plate as claimed in claim 11, wherein the groove has an irregular projection vertically projected on the bottom surface.

18. The light guide plate as claimed in claim 17, wherein the irregular projection has two orthogonal intersection sides and a tangent curve of the two orthogonal intersection sides.

19. The light guide plate as claimed in claim 18, wherein the irregular projection further has a triangle projection at an incident surface of the light guide plate.

20. The light guide plate as claimed in claim 11, wherein the groove has an L-shaped projection or a square projection vertically projected on the bottom surface.
